(19) United States
(12) Patent Application Publication
(10) Pub. No.: US 2014/0116348 A1
(43) Pub. Date: May 1, 2014

(54) PET CARRIER

(71) Applicant: BK ATELIER LIMITED, Hong Kong (CN)

(72) Inventor: Kam Kay Justine Zee KWOK, Hong Kong (HK)

(73) Assignee: BK ATELIER LIMITED, Hong Kong (CN)

(21) Appl. No.: 14/064,810

(22) Filed: Oct. 28, 2013

(30) Foreign Application Priority Data
Oct. 30, 2012 (CN) 201220565253.X

(51) Int. Cl. A01K 1/02

(52) U.S. Cl. CPC A01K 1/029
USPC 119/497

(57) ABSTRACT

The present invention discloses a pet carrier wherein the ,pet carrier is evenly perforated with ventilation holes. The pet carrier comprises four non-separable flexible panels: a bottom panel, a first-side panel, a second-side panel and a roof panel, in which the first-side panel, the second-side panel, and the roof panel can be folded onto the bottom panel to form a collapsed configuration. And the second configuration utilizes a continuous dual-directional zipper stitched along the perimeter of the four panels which can be connected together to form a three-dimensional enclosed carrier. This simple, lightweight and portable carrier allows for easy transportation and storage. The allover perforation of the pet carrier maximizes ventilation and breathability of the carrier thus reducing the risk of suffocation of the pet contained inside. It also serves the purpose of alleviating stress and anxiety of the pet by increasing comfortability and visibility of the exterior surrounding.

### Technical Field

The present invention relates generally to a portable device for small animals, and more particularly, to a pet carrier which is fully collapsible and perforated for ventilation purpose.

### BACKGROUND OF THE INVENTION

As the general standard of living improves, more and more people own pets. When traveling with their pets, pet owners usually use portable carriers. Prior art portable pet carriers with cut out mesh windows, which are poor in both ventilation and aesthetical appearance. Carriers with limited mesh openings may result in inadequate ventilation and may further lead to suffocation of the animals. Furthermore, these enclosed carriers do not allow good visibility of the surrounding environment and this may cause great discomfort, stress and anxiety to the animals.

in addition, prior art animal crate carriers tend to be rigid, bulky, difficult to store and transport.

### SUMMARY OF THE INVENTION

The object of this invention is to provide a simple, lightweight and portable pet carrier which can be fully collapsible so as to overcome the above deficiencies of poor ventilation and portability in existing technology.

According to this invention, the said pet carrier comprises: a carrier body having a plurality of ventilation holes evenly distributed thereon, wherein the pet carrier comprises four non-separable flexible panel portions: a bottom panel, a first-side panel, a second-side panel and a roof panel; in which the first-side panel, the second-side panel, and the roof panel can be folded onto the bottom panel to form a collapsed configuration; while the second configuration utilizes one continuous zipper stitched along the perimeter of the four panels in which the bottom panel, the first and the second side panels and the top panel are connected together to form a three-dimensional carrier for transporting pets.

According to one embodiment of the invention, the pet carrier is formed by a single piece of flat material.

According to one embodiment of the invention, the single piece of flat material is made up of four nonseparable flexible panels: one non-perforated bottom panel, two side panels and one roof panel.

According to one embodiment of the invention, the ventilation holes are perforated on the two flexible side panels, and the flexible roof panel.

According to one embodiment of the invention, the said material is selected from polymeric materials.

According to one embodiment of the invention, the solid polymeric material is selected from the group consisting of vinyl acetate, styrene-butadiene rubber, polyethylene, polyurethane, poly-vinyl chloride, synthetic fiber, polyethylene terephthalate, polypropylene, polycarbonate, or a combination of the above materials.

According to one embodiment of the invention, the shape of the ventilation holes can be circle, ellipse, square, rectangle, diamond, triangle, trapezium, star, heart or irregular shape.

According to another embodiment of the invention, the width of each ventilation hole ranges from 2 mm to 10 mm.

According to another embodiment of the invention, the distance between ventilation holes can range from 10 mm to 30 mm.

According to another embodiment of the invention, the continuous zipper is a dual-directional system which can be zipped and unzipped in both directions.

According to yet another embodiment of the invention, a handle is securely attached to the exterior of the roof panel.

According to yet another embodiment of the invention, the pet carrier is simple, lightweight and portable. It can be fully collapsed or rendered three-dimensional.

This simple, lightweight and portable carrier allows for easy transportation and storage. The allover perforation of the pet carrier is to increase visibility and comfortability that helps to alleviate anxiety of the pet and to maximize ventilation so as to prevent suffocation of the pet contained inside.

### BRIEF DESCRIPTION OF THE DRAWINGS

The features of the present invention are presented by the accompanying drawings. The invention, together with the advantages thereof may be best understood by reference to the following description taken in conjunction with the accompany drawings, wherein like reference signs identify like elements, and wherein:

FIG. 1 is an schematic view of the pet carrier according to the present invention, in which all the panels of the pet carrier are unfolded; and

FIG. 2 is a schematic view of the pet carrier according to the present invention, in which all the panels are connected together by closing the zipper to form a three-dimensional pet carrier.

### DETAILED DESCRIPTION OF THE INVENTION

The structure of the portable pet carrier of the present invention will be explained in detail with reference to the accompany drawings. The description and explanatory embodiments herein are merely used to elaborate on the present invention, not to limit the invention.

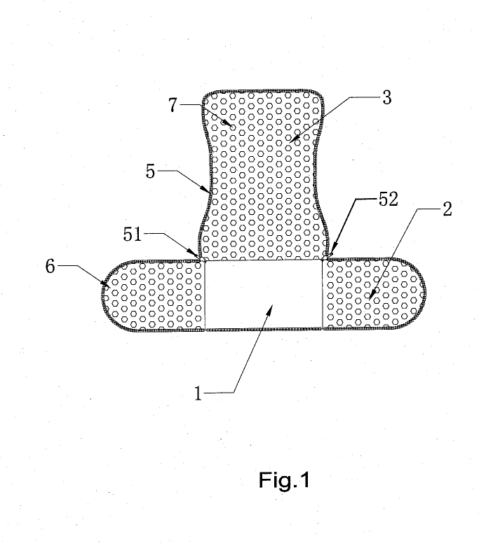

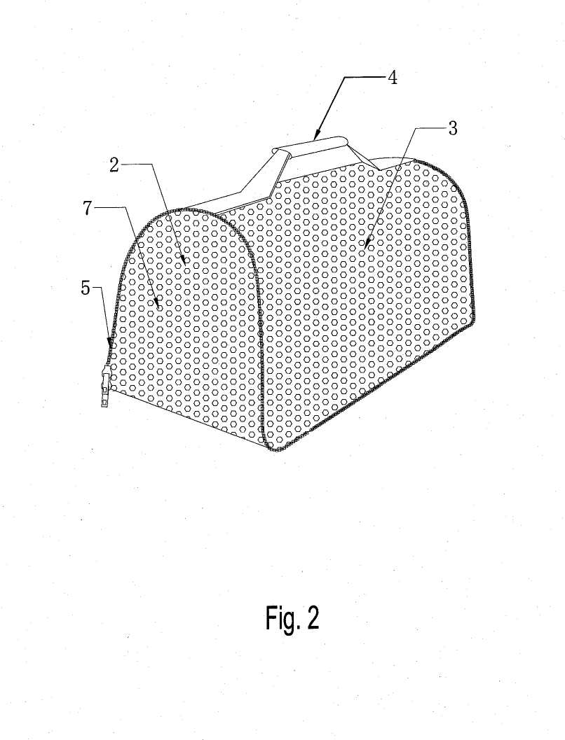

As illustrated in FIG. 1 and FIG. 2, there is shown a pet carrier, which comprises a carrier body that is fabricated by a flat piece of material. The said carrier body further comprises a bottom panel 1, a first-side panel 2, a second-side panel 6 and a roof panel 3, in which a continuous dual-directional zipper 5 is stitched along the perimeter of the material. A plurality of ventilation holes 7 are evenly distributed on the first-side panel 2, the second-side panel 6 and the roof panel 3.

As illustrated in FIG. 1, in one embodiment of the invention, the zipper 5 is a dual-directional system, which includes two zipper heads 51 and 52. Along the perimeter of the panels, the zipper head 51 can reach the other zipper head 52; likewise, along the perimeter of the panels, the zipper head 52 can also reach the other zipper head 51, so that the bottom panel 1, the two side panels 2 and 6, and the roof panel 3 can be connected together to form a three-dimensional pet carrier. Preferably, a handle 4 is attached to the exterior of the carrier body which is to facilitate transport of this pet carrier.

The ventilation holes 7 are evenly distributed on the two side panels 2 and 6, and the roof panel 3. Generally, the bottom panel 1 does not contain ventilation holes 7. However, in certain cases, the ventilation holes 7 can also be perforated on the bottom panel 1, if desired.

The pet carrier of the invention can be folded completely flat when it is not in use. Specifically, the pet carrier can be fold in such a manner that the first-side panel 2, the second-side panel 6, and the roof panel 3 are folded onto the bottom panel 1, so as to obtain a collapsed configuration for ease transportation and storage.

The ventilation holes 7 are created using an allover perforation technology. The ventilation holes 7 can be shaped the same or differently to create various patterns. Generally, the ventilation holes 7 can be shaped as a circle, an oval, a square, a diamond, a triangle, a star or a heart, and so on. Generally, the width of each ventilation hole ranges from 2 mm to 10 mm, and the distance between the holes ranges from 10 mm to 30 mm. The above dimensions can be changed according to the actual circumstances. For example, in one embodiment of the invention, each ventilation hole has a width of 2 mm. In another embodiment of the invention each ventilation hole has a width of 5 mm. In another embodiment of the invention, each ventilation hole has a width of 10 mm. In another embodiment of the invention, the said distance between the ventilation holes can be 10 mm. In another embodiment of the invention, the said separation distance can be 20 mm. In yet another embodiment of the invention, the said separation distance can be 30 mm.

In one embodiment of the invention, the majority (at least 50% or above) of the surface area of the carrier body must be perforated with ventilation holes 7 so as to achieve optimal visibility and ventilation for pet therein.

The pet carrier may be made of solid polymeric material. However, any other material can also be used. Preferably, the said polymeric material is selected from the group consisting of ethylene vinyl acetate (EVA), styrene-butadiene rubber (SBR), polyethylene (PE), polyurethane (PU), poly-vinyl chloride (PVC), synthetic fiber, polyethylene terephthalate (PET), polypropylene (PP), polycarbonate (PC), or a combination of the above materials. In another embodiment, the material may be cotton or paper cardboards.

In other words, this simple, lightweight and portable carrier allows easy transportation and storage. The allover perforation of the carrier is to increase visibility and comfortability that helps to alleviate stress and anxiety of the pet and to maximize ventilation so as to prevent suffocation of the pet contained inside.

It will be obvious to those skilled in the art that various changes and modifications can be made without departing from the true spirit and scope of the invention.

However, it should be appreciated, that all the embodiments of the present invention described above are illustrative only, and all the changes and modifications made by those skilled in the art are covered by the appended claims.

1. A pet carrier, the pet carrier comprising:
a carrier body having a plurality of ventilation holes evenly distributed thereon, wherein the carrier body further comprises a bottom panel, a first-side panel, a second Side panel and a roof panel, in which the first-side panel, the second-side panel and the roof panel can be folded onto the bottom panel to form a collapsed configuration; and
a zipper being stitched along the perimeter of the constituent panels, by which the bottom panel, the first-side panel, the second-side panel and the roof panel can be connected together to form an enclosed three-dimensional carrier case.

2. The pet carrier according to claim 1, wherein the ventilation holes are evenly perforated and distributed on the first-side panel, the second-side panel and the roof panel respectively.

3. The pet carrier according to claim 1, wherein the three-dimensional carrier case is constructed from a single piece of flat material.

4. The pet carrier according to claim 3, wherein the flat material is made of polymeric material.

5. The pet carrier according to claim 4, wherein the polymeric material is selected from a group consisting of ethylene vinyl acetate, styrene-butadiene rubber, polyethylene, polyurethane, poly-vinyl chloride, synthetic fiber, polyethylene terephthalate, polypropylene, polycarbonate or a combination of the above materials.

6. The pet carrier according to claim 1, wherein the ventilation holes can come in a variety of shapes, which can comprise a circle, an oval, a square, a diamond, a triangle, a star or a heart.

7. The pet carrier according to claim 1, wherein the width of each ventilation hole can range from 2 mm to 10 mm.

8. The pet carrier according to claim 1, Wherein a distance between the ventilation holes can range from 10 mm to 30 mm.

9. The pet carrier according to claim 1, wherein the zipper is a versatile dual-directional system which can be zipped and unzipped in both directions.

10. The pet carrier according to claim 1, wherein a handle is securely attached to the exterior of the roof panel enabling portability of the carrier when it is fully enclosed.
